(19) United States
(12) Patent Application Publication
(10) Pub. No.: US 2014/0311720 A1
(43) Pub. Date: Oct. 23, 2014

(54) Multiple Bank Flattened Tube And Folded Fin Heat Exchanger

(71) Applicant: Carrier Corporation, Farmington, CT (US)

(72) Inventors: Michael F. Taras, Fayetteville, NY (US); Arindom Joardar, Jamesville, NY (US); Tobias H. Sienel, Baldwinsville, NY (US); Mel Woldesemayat, Liverpool, NY (US); Bruce J. Poplawski, Mattydale, NY (US)

(73) Assignee: Carrier Corporation, Farmington, CT (US)

(21) Appl. No.: 14/210,682

(22) Filed: Mar. 14, 2014

Related U.S. Application Data
(60) Provisional application No. 61/790,073, filed on Mar. 15, 2013.

(51) Int. Cl. F28D 1/053; B23P 15/26

(52) U.S. Cl. CPC F28D 1/05391; B23P 15/26
USPC 165/150; 29/890.046

(57) ABSTRACT

A multiple bank, flattened tube heat exchange unit includes a first tube bank including a plurality of flattened tube segments extending longitudinally in spaced parallel relationship and a second tube bank including a plurality of flattened tube segments extending longitudinally in spaced parallel relationship, the second tube bank disposed behind the first tube bank at a desired spacing gap. A first plurality of folded fins is disposed between respective adjacent pairs of the heat exchange tube segments of the first tube bank and a second plurality of folded fins disposed between respective adjacent pairs of the heat exchange tube segments of the second tube bank.

### CROSS REFERENCE TO RELATED APPLICATIONS

This application claims the benefit of U.S. Provisional patent application Ser. No. 61/790,073 filed Mar. 15, 2013, the entire contents of which are incorporated herein by reference.

### BACKGROUND OF THE INVENTION

This invention relates generally to heat exchangers and, more particularly, to multiple tube bank heat exchange unit and manifold assembly.

Heat exchangers have long been used as evaporators and condensers in heating, ventilating, air conditioning and refrigeration (HVACR) applications. Historically, these heat exchangers have been round tube and plate fin (RTPF) heat exchangers. However, all aluminum flattened tube plate fin heat exchangers are finding increasingly wider use in industry, including the HVACR industry, due to their compactness, thermal-hydraulic performance, structural rigidity, lower weight and reduced refrigerant charge, in comparison to conventional RTPF heat exchangers. Flattened tubes commonly used in HVACR applications typically have an interior subdivided into a plurality of parallel flow channels. Such flattened tubes are commonly referred to in the art as multi-channel tubes, mini-channel tubes or micro-channel tubes.

A typical flattened tube plate fin heat exchanger includes a first manifold, a second manifold, and a single tube bank formed of a plurality of longitudinally extending flattened heat exchange tubes disposed in spaced parallel relationship and extending between the first manifold and the second manifold. The first manifold, second manifold and tube bank assembly is commonly referred to in the heat exchanger art as a slab. Additionally, a plurality of fins are disposed between the neighboring pairs of heat exchange tubes for increasing heat transfer between a fluid, commonly air in HVACR applications, flowing over the outer surface of the flattened tubes and along the fin surfaces and a fluid, commonly refrigerant in HVACR applications, flowing inside the flattened tubes. Such single tube bank heat exchangers, also known as single slab heat exchangers, have a pure cross-flow configuration.

Double bank flattened tube and fin heat exchangers are also known in the art. In conventional double bank flattened tube and fin heat exchangers are typically formed of two conventional fin and tube slabs, one spaced behind the other. For example, U.S. Pat. No. 6,964,296 B2 and U.S. Patent Application Publication 2009/0025914 A1 disclose embodiments of double bank, multichannel flattened tube heat exchanger. A challenge in manufacturing multiple bank heat exchangers is maintaining a desired spacing between the tube individual tube banks, particularly during fabrication of the multiple bank heat exchangers, as well as aligning the heat exchanger slabs of large size, while installing into the system or sub-system.

### SUMMARY OF THE INVENTION

A multiple bank, flattened tube and fin heat exchange unit is provided wherein spacing between tube banks is achieved by a folded fin(s) which overhang at least one of the leading edge and the trailing edge of the heat exchange tubes of the heat exchange unit.

A multiple bank, flattened tube heat exchange unit includes a first tube bank including a plurality of flattened tube segments extending longitudinally in spaced parallel relationship and a second tube bank including a plurality of flattened tube segments extending longitudinally in spaced parallel relationship, the second tube bank disposed behind the first tube bank. A first plurality of folded fins is disposed between respective adjacent pairs of the heat exchange tube segments of the first tube bank and a second plurality of folded fins disposed between respective adjacent pairs of the heat exchange tube segments of the second tube bank. At least one of the first plurality of folded fins overhangs the trailing edges of the first flatted heat exchange tube segments and extends into the spacing gap or at least one of the second plurality of folded fins overhangs the leading edges of the second flattened heat exchange tube segments and extends into the spacing gap.

### BRIEF DESCRIPTION OF THE DRAWINGS

For a further understanding of the disclosure, reference will be made to the following detailed description which is to be read in connection with the accompanying drawing, where:

FIG. 1 is a diagrammatic illustration of an embodiment of a multiple tube bank, flattened tube finned heat exchange unit as disclosed herein;

FIG. 2 is a top, plan view, partly in section, of the embodiment of the multiple tube bank, flattened tube finned heat exchange unit of FIG. 1;

FIG. 3 is a sectioned side elevation view of the embodiment of the multiple tube bank, flattened tube finned heat exchange unit of FIG. 1;

FIG. 4 is a sectioned side elevation view of another embodiment of the multiple tube bank, flattened tube finned heat exchange unit as disclosed herein;

FIG. 5 is a sectioned side elevation view of a further embodiment of the multiple tube bank, flattened tube finned heat exchange unit as disclosed herein;

FIG. 6 is a sectioned side elevation view of a further embodiment of the multiple tube bank, flattened tube finned heat exchange unit as disclosed herein; and

FIG. 7 is a perspective view of an exemplary embodiment of a ribbon-like folded fin of the heat exchange unit of FIG. 1.

### DETAILED DESCRIPTION

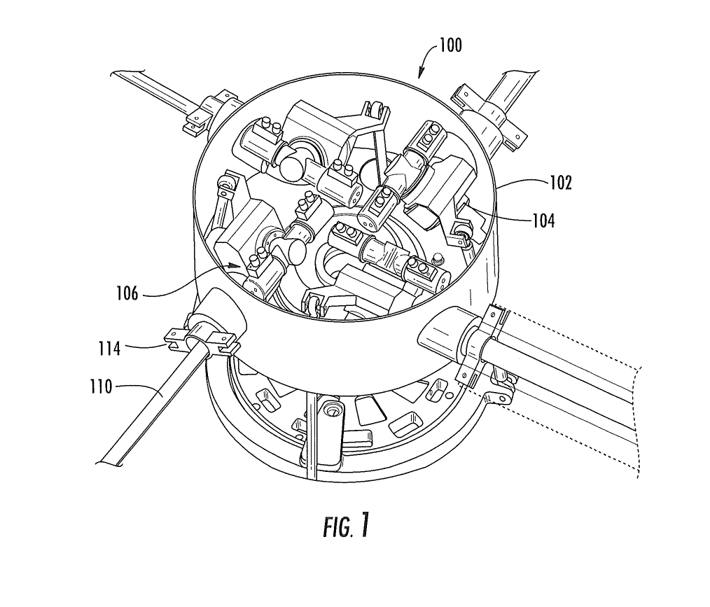

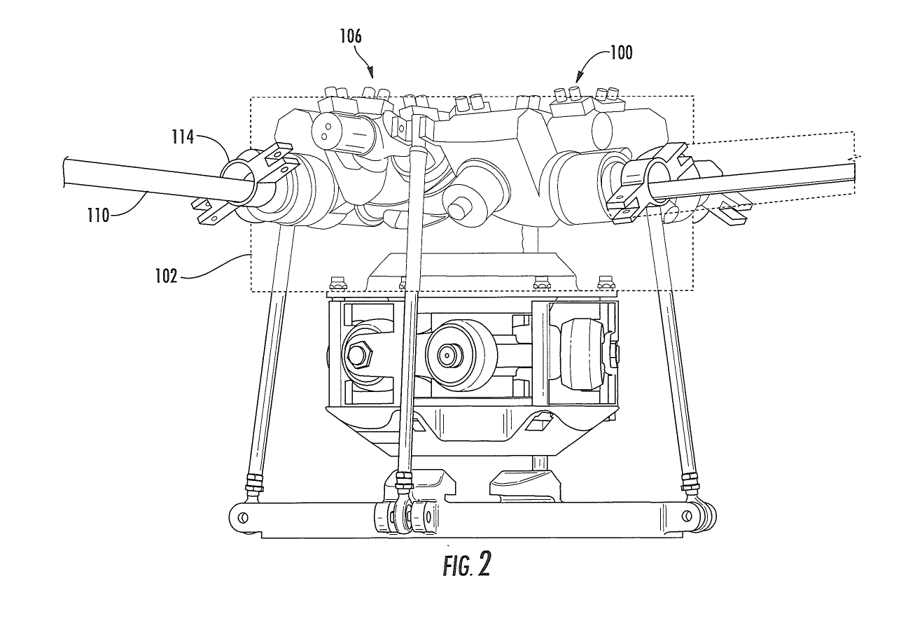

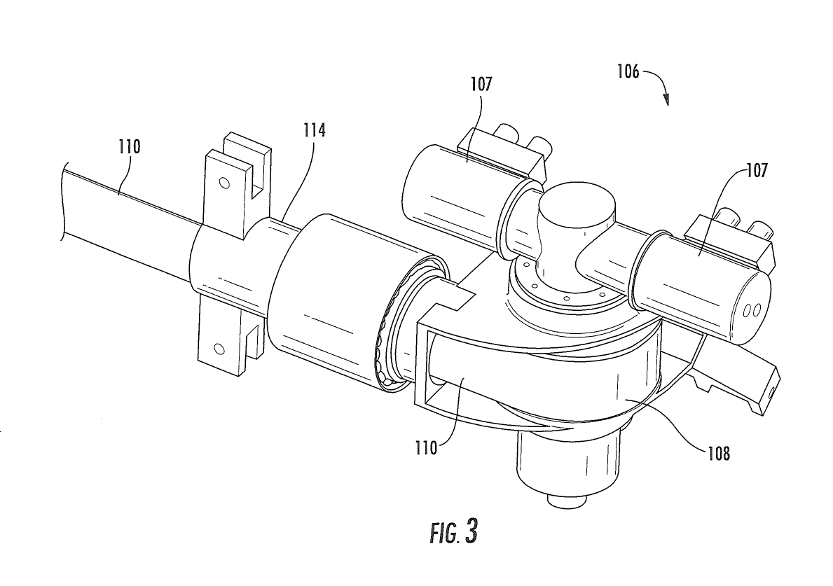

An exemplary embodiment of a multiple bank flattened tube finned heat exchange unit, generally designated 10, in accordance with the disclosure is depicted in FIGS. 1 and 2. As depicted therein, the multiple bank flattened tube finned heat exchange unit 10 includes a first tube bank 100 and a second tube bank 200 that is disposed behind the first tube bank 100, that is downstream with respect to air flow, A, through the heat exchange unit. The first tube bank 100 may also be referred to herein as the front heat exchanger slab 100 and the second tube bank 200 may also be referred to herein as the rear heat exchanger slab 200.

The first tube bank 100 includes a first manifold 102, a second manifold 104 spaced apart from the first manifold 102, and a plurality of heat exchange tube segments 106, including at least a first and a second tube segment, extending longitudinally in spaced parallel relationship between and connecting the first manifold 102 and the second manifold 104 in fluid communication. The second tube bank 200 includes a first manifold 202, a second manifold 204 spaced apart from the first manifold 202, and a plurality of heat exchange tube segments 206, including at least a first and a second tube segment, extending longitudinally in spaced parallel relationship between and connecting the first manifold 202 and the second manifold 204 in fluid communication.

Each tube bank 100, 200 may further include guard or “dummy” tubes (not shown) extending between its first and second manifolds at the top of the tube bank and at the bottom of the tube bank. One or more dummy tubes could also be installed with the arrays of heat exchange tubes 106, 206 forming the tube banks 100, 200 at spaced intervals, for example at the mid-point or quarter-points of the tube arrays. These dummy tubes do not convey refrigerant flow, but add structural support to the tube bank and protect the uppermost and lowermost fins. These tubes, if installed within the heat exchanger core, may prevent cross-conduction from the tubes associated with one refrigerant pass to the tubes associated with another refrigerant pass and/or reduce thermo-mechanical fatigue via special thermal gradient reduction.

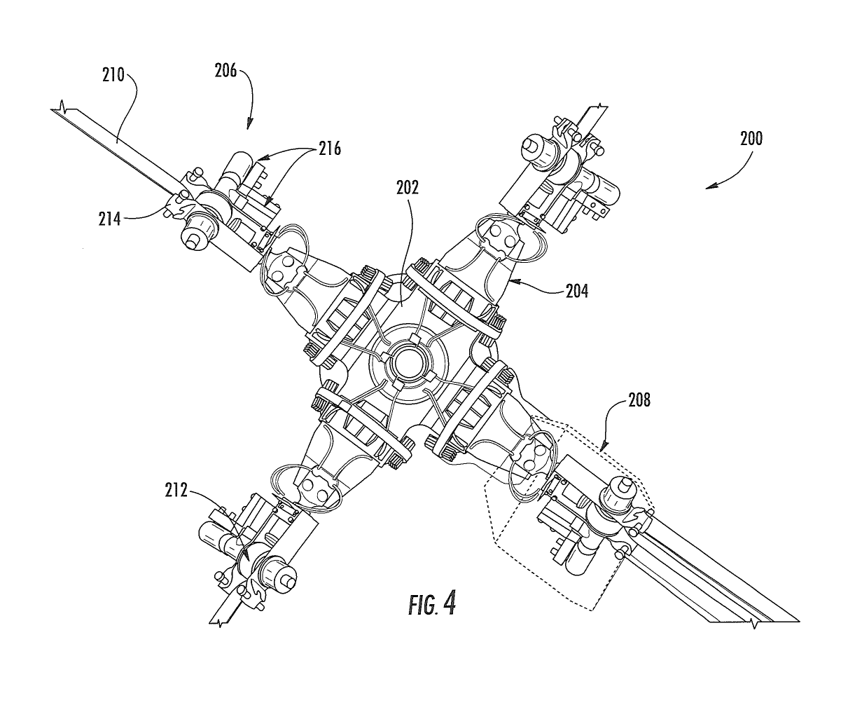

Referring now to FIGS. 3-6, each of the heat exchange tube segments 106, 206 comprises a flattened heat exchange tube having a leading edge 108, 208, a trailing edge 110, 210, an upper flat surface 112, 212, and a lower flat surface 114, 214. The leading edge 108, 208 of each heat exchange tube segment 106, 206 is upstream of its respective trailing edge 110, 210 with respect to airflow through the heat exchanger 10. In the embodiments depicted in FIGS. 3-6, the respective leading and trailing portions of the flattened tube segments 106, 206 are rounded thereby providing blunt leading edges 108, 208 and trailing edges 110, 210. However, it is to be understood that the respective leading and trailing portions of the flattened tube segments 106, 206 may be formed in other configurations.

The interior flow passage of each of the heat exchange tube segments 106, 206 of the first and second tube banks 100, 200, respectively, may be divided by interior walls into a plurality of discrete flow channels 116, 216 that extend longitudinally the length of the tube from an inlet end of the tube to an outlet end of the tube and establish fluid communication between the respective headers of the first and the second tube banks 100, 200. The flow channels 116, 216 may have a circular cross-section, a rectangular cross-section or other non-circular cross-section. In the embodiment of the multi-channel heat exchange tube segments 106, 206 depicted in FIGS. 3-6, the heat exchange tube segments 106 of the first tube bank 100 and the heat exchange segments 206 of the second tube bank 200 have the same depth, i.e. expanse in the direction of airflow. However, it is to be understood that the depth of the heat exchange segments 106 may be different than the depth of the heat exchange segments 206. Also, the interior flow passages of the heat exchange tube segments 106, 206 may be divided into the same or into a different number of discrete flow channels 116, 216.

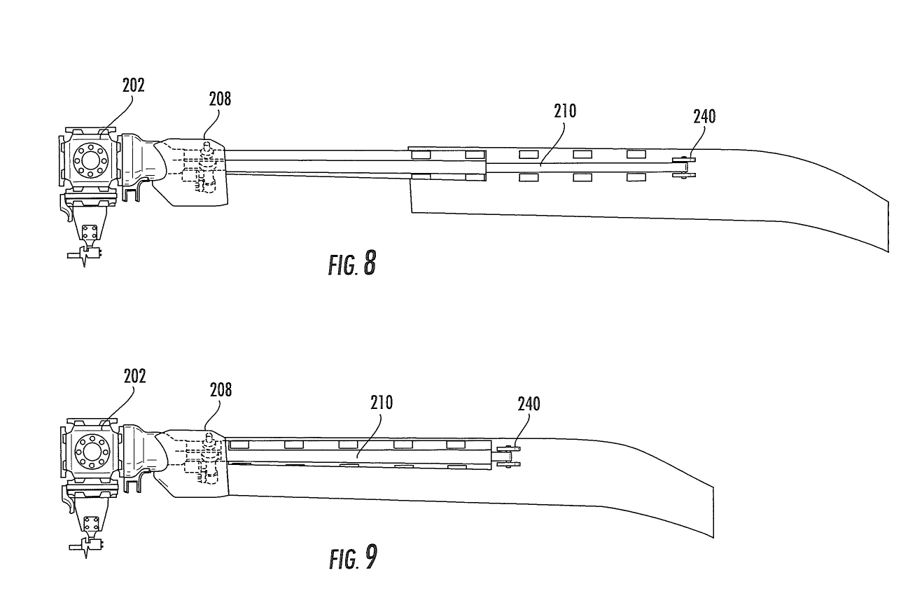

Each tube bank 100, 200 further includes a plurality of folded fins 120, 220 disposed between adjacent flattened heat exchange tubes 106, 206 of the first and second tube banks 100, 200. Each folded fin 120, 220 is formed of a single continuous strip of fin material tightly folded, for example in a ribbon-like fashion such as depicted in FIG. 7, providing a plurality of closely spaced fins 122, 222. Each fold 124, 224 also forms a fin base 126, 226 extending between adjacent fins 122, 222 which extend generally orthogonal to the fin base 126, 226.

Typically, the fin density of the closely spaced fins 122, 222 of each continuous folded fin 120, 220 may be about 18 to 25 fins per inch, but higher or lower fin densities may also be used. The respective fin densities of the folded fins 120 of the first tube bank 100 and of the folded fins 220 of the second tube bank 200 may be the same or may be different. The fin densities of the folded fins 120, 220 may be the same throughout their respective tube banks or may differ between rows within the same tube bank. Heat exchange between the refrigerant flow, R, and air flow, A, passing through the flow passages 125, 225 formed by the folds 124, 224, occurs through the outer surfaces 112, 114 and 212, 214, respectively, of the heat exchange tube segments 106, 206, collectively forming the primary heat exchange surface, and also through the heat exchange surface of the fins 122, 222 of the folded fins 120, 220, collectively forming the secondary heat exchange surface.

When the multiple bank flattened tube heat exchange unit 10 is assembled, at least one folded fin 120, 220 is disposed between each pair of adjacent heat exchange tube segments 106, 206 to extend along the longitudinal extent of the heat exchange tube segments 106, 206 such as best seen in FIGS. 1 and 2. So installed, the fin bases 126, 226 contact the upper surfaces 112, 212 and the lower surfaces 114, 214 of the heat exchange segments 106, 206 and the fins 122, 222 extend generally orthogonal to the heat exchange tube segments 106, 206. As illustrated in FIGS. 3-6, a portion of the folded fins 120 and/or the folded fins 220 extend beyond the depth of the heat exchange tube segments 106, 206. That is, a portion of the folded fins overhangs the leading edge or the trailing edge of the heat exchange tube segments. As will be discussed further, the portion or portions of the folded fins overhanging the heat exchange tube segments maintain the desired spacing between the first tube bank 100, i.e. the forward heat exchanger slab with respect to airflow through the heat exchange unit 10, and the second tube bank 200, i.e. the aft heat exchanger slab with respect to airflow through the heat exchange unit 10.

Referring now to FIG. 3, the second tube bank 200 is disposed behind the first tube bank 100 with each heat exchange tube segment 206 directly aligned with a respective heat exchange tube segment 106 and with the leading edges 208 of the heat exchange tube segments 206 of the second tube bank 200 spaced from the trailing edges 110 of the heat exchange tube segments 106 of the first tube bank 100 by a desired spacing. In this embodiment, a portion 122 of each folded fin 120 extends aft of and overhangs the trailing edge 110 of the heat exchange tube segment 106 and a portion 222 of each folded fin 220 extends forward of and overhangs the leading edge 208 of the heat exchange tube segment 206. The trailing edges of the overhanging portions 122 and the leading edges of the overhanging portions 222 interface between the trailing edge 110 of the heat exchange tube segment 106 and the leading edge 208 of the heat exchange tube segment 206, thereby spanning the gap between the trailing edge 110 of the heat exchange tube segment 106 of the first tube bank 100 and the leading edge 208 of the heat exchange tube segment 206 of the second tube bank 200.

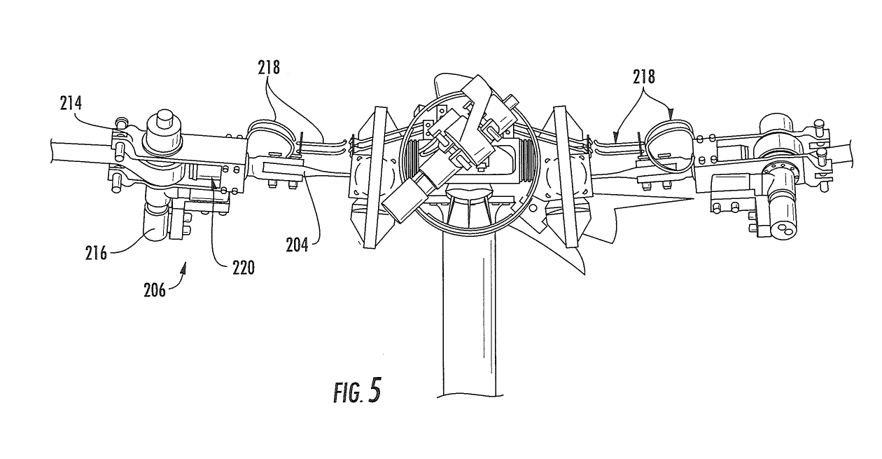

Referring now to FIG. 4, the second tube bank 200 is disposed behind the first tube bank 100 with the heat exchange tube segments 206 disposed in a staggered relationship with the heat exchange tube segments 106, that is not in direct alignment, with the heat exchange tube segments 106. The leading edges 208 of the heat exchange tube segments 206 of the second tube bank 200 are again spaced from the trailing edges 110 of the heat exchange tube segments 106 of the first tube bank 100 by a desired spacing. In this embodiment, a portion 122 of each folded fin 120 extends aft of and overhangs the trailing edge 110 of the heat exchange tube segment 106 and a portion 222 of each folded fin 220 extends forward of and overhangs the leading edge 208 of the heat exchange tube segment 206. Again, the trailing edges of the overhanging portions 122 and the leading edges of the overhanging portions 222 interface between the trailing edge 110 of the heat exchange tube segment 106 and the leading edge 208 of the heat exchange tube segment 206, thereby spanning the gap between the trailing edge 110 of the heat exchange tube segment 106 of the first tube bank 100 and the leading edge 208 of the heat exchange tube segment 206 of the second tube bank 200. As mentioned hereabove, the heat exchange tube segments 106 and 206 in FIGS. 3 and 4 may be of different depths, as well as fin overhang portions 122 and 222 may be of different dimensions. Furthermore, the heat exchange tube segments 106 and 206 may have the associated clips or other fixture elements to hold the heat exchange tube segments 106 and 206 in place during the assembly process.

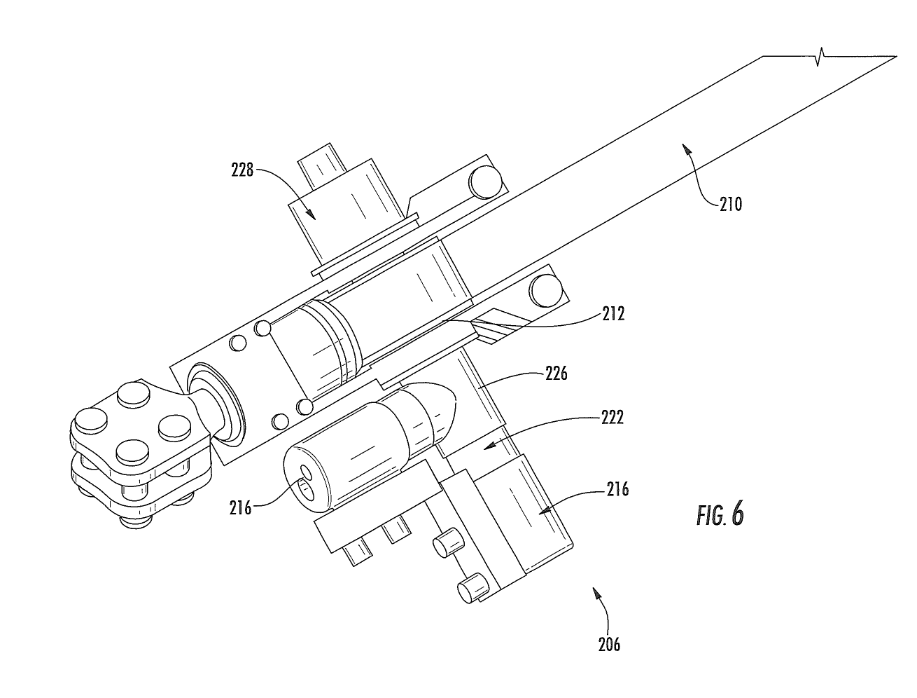

Referring now to FIG. 5, the second tube bank 200 is disposed behind the first tube bank 100 with each heat exchange tube segment 206 directly aligned with a respective heat exchange tube segment 106 and with the leading edges 208 of the heat exchange tube segments 206 of the second tube bank 200 spaced from the trailing edges 110 of the heat exchange tube segments 106 of the first tube bank 100 by a desired spacing. In this embodiment, each folded fin 120 merely extends to, and is aligned with, the trailing edges 110 of the heat exchange tube segments 106 rather than overhanging the trailing edges 110. However, folded fins 220 have a portion 222 that overhangs the leading edges 208 of the heat exchange tube segments 206 and extends forward into the spacing gap between the heat exchange tubes 106 of the first tube bank 100 and the heat exchange tube segments 206 of the second tube bank 200. The leading edges of the overhanging portions 222 interface with the trailing edges of the folded fins 120, thereby spanning the spacing gap between the trailing edge 110 of the heat exchange tube segment 106 of the first tube bank 100 and the leading edge 208 of the heat exchange tube segment 206 of the second tube bank 200. Thus, the desired spacing gap between the heat exchange tube segments 106 of the first tube bank 100 and the heat exchange tube segments 206 of the second tube bank 200 may be maintained. Once again, the heat exchange tube segments 106 and 206 may have clips or other fixture elements to be held in place during the assembly process.

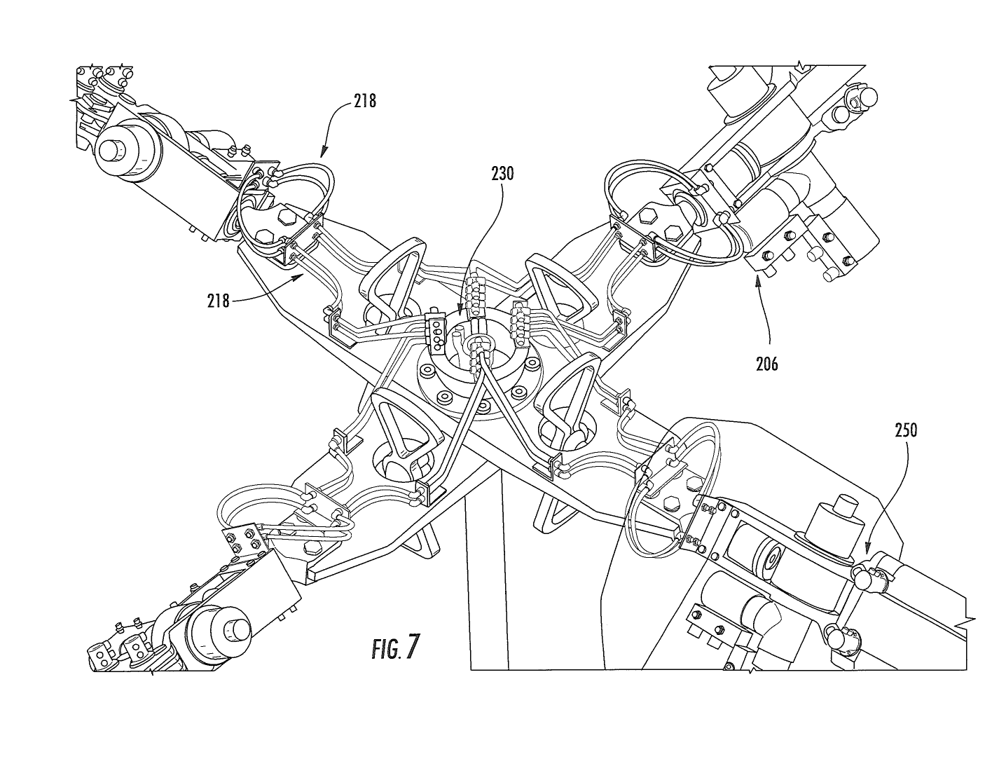

Referring now to FIG. 6, the second tube bank 200 is disposed behind the first tube bank 100 with the heat exchange tube segments 206 disposed in a staggered relationship with the heat exchange tube segment 106, that is not in direct alignment, with the heat exchange tube segments 106. The leading edges 208 of the heat exchange tube segments 206 of the second tube bank 200 are again spaced from the trailing edges 110 of the heat exchange tube segments 106 of the first tube bank 100 by a desired spacing. In this embodiment, a portion 122 of each folded fin 120 extends forward of and overhangs the leading edge 108 of the heat exchange tube segment 106, but the trailing edges of the folded fins 120 merely extend to, and do not overhang, the trailing edges 110 of the heat exchange tube segments 106. Similarly, a portion 222 of each folded fin 220 extends forward of and overhangs the leading edge 208 of the heat exchange tube segment 206. In this embodiment, the leading edges of the overhanging portions 222 interface with the trailing edges of the folded fins 120 and/or the trailing edges 110 of the heat exchange tube segments 106, thereby spanning the gap between the trailing edge 110 of the heat exchange tube segment 106 of the first tube bank 100 and the leading edge 208 of the heat exchange tube segment 206 of the second tube bank 200. In this embodiment, the heat exchange tube segments 106 are held in place by the folded fins 220 during the assembly process, so that no additional fixture elements would be required. It has to be understood that the most preferred staggered arrangement is when the heat exchange tube segments 106 in the first tube bank 100 and the heat transfer tube segments 206 in the second tube bank 200 are shifted to be positioned in the middle of the heights of the folded fins 220 and 120 respectively.

In an embodiment, during fabrication of the multiple bank flattened tube heat exchange unit 10, in each of the first tube bank 100 and the second tube bank 200, the heat exchange tube segments 106, 206 are first assembled to their respective manifolds 102, 104; 202, 204 by inserting the respective ends of the plurality of heat exchange tube segments 106 into longitudinally spaced slots formed in the manifolds 102 and 104 and by inserting the respective ends of the plurality of heat exchange tube segments 206 into longitudinally spaced slots formed in the manifolds 202 and 104. The plurality of folded fins 120 are then inserted between the sets of adjacent pairs of the heat exchange tube segments 106 and the plurality of folded fins 220 are inserted between the sets of adjacent pairs of the heat exchange tube segments 206. The second tube bank 200 is positioned behind the first tube bank 100 in the desired configuration, for example in one of the configurations shown in FIGS. 3-6, with the desired spacing between the leading edges 208 of the heat exchange tube segments 206 of the second tube bank 200 and the trailing edges 110 of the heat exchange tube segments 106 of the first tube bank 100 being maintained by the overhanging portion(s) 122, 222 of the fins 120, 220. The assembled heat exchange unit 10 is then bound with wire and placed in a brazing furnace. The assembled heat exchange unit 10 is heated in the brazing furnace (e.g., controlled atmosphere brazing system) to a temperature and for a time sufficient to bond (e.g., braze) the folded fins 120 to the heat exchange tube segments 106 and to bond the folded fins 220 to the heat exchange tube segments 206, and to bond the plurality of heat exchange tube segments 106 at their respective ends to the respective manifolds 102, 104, and to bond the plurality of heat exchange tube segments 206 at their respective manifolds 202, 204. During the brazing process, the interfacing portions of the folded fins 120 and 220 are also be bonded together, thereby ensuring that the desired spacing between the heat exchange tube segments 106 of the first tube bank 100 and the heat exchange tube segments 206 of the second tube bank 200 is maintained during shipping and field installation of the heat exchange unit 10, as well as during subsequent operation as a heat exchanger. Bonding of the fin edges assures tube bank relative position during handling and subsequent assembly into the frame, as well as adds to the heat exchanger structural rigidity.

In an alternative embodiment, the first tube bank 100 and the second tube bank 200 are assembled, then placed and fixed in a spaced relationship with respect to each other, and then brazed. In this embodiment, heat exchange tube segments 106 assembled to first manifold 102 and second manifold 104. Fins 120 are also assembled to heat exchange tube segments 106, to define first tube bank 100. Heat exchange tube segments 206 assembled to first manifold 202 and second manifold 204. Fins 200 are also assembled to heat exchange tube segments 206, to define second tube bank 200. Tube banks 100 and 200 are then positioned relative to each other and heated in a brazing furnace (e.g., controlled atmosphere brazing system) to a temperature and for a time sufficient to bond (e.g., braze) tube banks 100 and 200 to each other. As noted above, interfacing portions of the folded fins 120 and 220 are also bonded together. It has to be understood that the manifolds 102, 104, 202, and 204 may be pressed in when the two tube banks 100 and 200 are assembled and positioned relative to one another, prior to the brazing process, especially if at least one of the manifold pairs 102/104 and 202/204 represents a dual barrel manifold.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiments as illustrated in the drawing, it will be recognized by those skilled in the art that various modifications may be made without departing from the spirit and scope of the invention. Therefore, it is intended that the present disclosure not be limited to the particular embodiment(s) disclosed as, but that the disclosure will include all embodiments falling within the scope of the appended claims.

We claim:

1. A multiple bank, flattened tube heat exchange unit comprising:
a first tube bank including a first plurality of flattened heat exchange tube segments extending longitudinally in spaced parallel relationship and extending transversely between a leading edge and a trailing edge;
a second tube bank including a second plurality of flattened heat exchange tube segments extending longitudinally in spaced parallel relationship and extending transversely between a leading edge and a trailing edge, the second tube bank disposed behind the first tube bank at a desired spacing gap;
a first plurality of folded fins disposed between respective adjacent pairs of the plurality of first flattened tube segments of the first tube bank; and
a second plurality of folded fins disposed between respective adjacent pairs of the plurality of second flattened tube segments of the second tube bank;
wherein at least one of the first plurality of folded fins overhangs the trailing edges of the first flatted heat exchange tube segments and extends into the spacing gap or at least one of the second plurality of folded fins overhangs the leading edges of the second flattened heat exchange tube segments and extends into the spacing gap.

2. The heat exchange unit as recited in claim 1 wherein:
the first plurality of folded fins includes folded fins having a portion overhanging the trailing edges of the first plurality of heat exchange tube segments and extending into the spacing gap; and
the second plurality of folded fins includes folded fins having a portion overhanging the leading edges of the second plurality of heat exchange tube segments and extending into the spacing gap and interfacing with the overhanging portions of the first plurality of folded fins extending into the spacing gap.

3. The heat exchange unit as recited in claim 1 wherein:
the first plurality of folded fins includes folded fins extending to and aligned with the trailing edges of the first plurality of heat exchange tube segments; and
the second plurality of folded fins includes folded fins having a portion overhanging the leading edges of the second plurality of heat exchange tube segments and extending into the spacing gap and interfacing with the first plurality of folded fins.

4. The heat exchange unit as recited in claim 3 wherein:
the first plurality of folded fins include folded fins having a portion overhanging the leading edges of the first plurality of heat exchange tube segments.

5. The heat exchanger unit as recited in claim 1 wherein:
the second plurality of folded fins includes folded fins extending to and aligned with the leading edges of the second plurality of heat exchange tube segments; and
the first plurality of folded fins includes folded fins having a portion overhanging the trailing edges of the first plurality of heat exchange tube segments and extending into the spacing gap and interfacing with the second plurality of folded fins.

6. The heat exchange unit as recited in claim 1 wherein:
a trailing edge of at least one of the first plurality of folded fins is bonded to a leading edge of at least one of the second plurality of folded fins.

7. The heat exchange unit as recited in claim 1 wherein the heat exchange tube segments of the second plurality of heat exchange tube segments are disposed in an in-line arrangement with the heat exchange tube segments of the first plurality of heat exchange tube segments.

8. The heat exchange unit as recited in claim 1 wherein the heat exchange tube segments of the second plurality of heat exchange tube segments are disposed in a staggered arrangement with the heat exchange tube segments of the first plurality of heat exchange tube segments.

9. The heat exchange unit as recited in claim 1 wherein the first plurality of flattened heat exchange tube segments and the second plurality of flattened heat exchange tube segments have at least one dimension that is not equal.

10. The heat exchange unit as recited in claim 9 wherein the first plurality of flattened heat exchange tube segments and the second plurality of flattened heat exchange tube segments have different depths.

11. The heat exchange unit as recited in claim 1 wherein the at least one of the first plurality of folded fins overhangs the trailing edges of the first flatted heat exchange tube segments by a first distance and the at least one of the second plurality of folded fins overhangs the leading edges of the second flattened heat exchange tube segments by a second distance, the first distance and second distance being unequal.

12. A method of forming a multiple bank, flattened tube heat exchange unit comprising:
obtaining a first tube bank including a first plurality of flattened heat exchange tube segments extending longitudinally in spaced parallel relationship and extending transversely between a leading edge and a trailing edge, a first plurality of folded fins disposed between respective adjacent pairs of the plurality of first flattened tube segments of the first tube bank;
obtaining a second tube bank including a second plurality of flattened heat exchange tube segments extending longitudinally in spaced parallel relationship and extending transversely between a leading edge and a trailing edge, a second plurality of folded fins disposed between respective adjacent pairs of the plurality of second flattened tube segments of the second tube bank;
disposing the second tube bank behind the first tube bank at a desired spacing gap;
wherein at least one of the first plurality of folded fins overhangs the trailing edges of the first flatted heat exchange tube segments and extends into the spacing gap or at least one of the second plurality of folded fins overhangs the leading edges of the second flattened heat exchange tube segments and extends into the spacing gap; and
placing the first tube bank and the second tube bank in a brazing environment to bond at least one of the first plurality of folded fins with least one of the second plurality of folded fins.
